(19) United States
(12) Patent Application Publication
(10) Pub. No.: US 2008/0068930 A1
(43) Pub. Date: Mar. 20, 2008

(54) Method and Device for Setting a Calendar Work of a Clock, Particularly of a Radio-Controlled Clock, After Changing the Battery

(76) Inventors: Wilfried Richter, Villingen-Schwenningen (DE); Gunter Megner, Uhldingen (DE)

Correspondence Address: NATH & ASSOCIATES, 112 South West Street, Alexandria, VA, 22314, US

(21) Appl. No.: 11/597,885

(22) PCT Filed: Mar. 4, 2005
(86) PCT No.: PCT/EP05/02318

§ 371 Date: Nov. 29, 2006

(30) Foreign Application Priority Data
Jun. 15, 2004 (DE) 10 2004 028 580.2

(51) Int. Cl. G04B 19/24; G04C 10/04; G04G 19/00

(52) U.S. Cl. 368/34

(57) ABSTRACT

The invention relates to a method and device for setting a calendar work of a watch, particularly of a radio-controlled clock, after changing the battery. The inventive method comprises the following steps: a. determining if the battery needs to be changed; b. bringing the calendar work into a predetermined reference position; c. determining if the battery has been changed; d. determining the actual date to be set on the calendar work, and; e. setting the determined date on the calendar work starting from the reference position. In order to able to carry out this method, a device having the following individual components is required: a. means for determining if the battery needs to be changed; b. means for bringing the calendar work into a predetermined reference position; c. means for determining if the battery has been changed; d. means for determining the actual date to be set on the calendar work, and; e. means for setting the determined date on the calendar work starting from the reference position.

The invention relates to a method for setting the calendar work of a clock, particularly a radio-controlled clock, after the battery has been changed, in accordance with the preamble of patent claim 1, as well as to a device for setting the calendar work of a clock, particularly a radio-controlled clock, after the battery has been changed, in accordance with the preamble of claim 10.

In a battery-operated clock, e.g., a wristwatch, a kitchen clock, or the like, it is often very laborious, after changing the battery (or batteries), to set the current time and, particularly, to set the current calendar date. This applies both to clocks with an analogue display and, all the more so, to clocks with a digital display, e.g., those with a liquid-crystal display. Even so-called radio-controlled clocks, which set the current time and the calendrical date automatically after receiving a radio signal, frequently require a long period of time before the correct date and date can be read from the display.

While a variety of methods and devices are known for quickly setting the clock time, these known methods and devices seldom result in a rapid setting of the date display.

The goal of the invention, consequently, is to propose a method and a device for setting a calendar work on a clock, such that the calendar work can very quickly display the current calendrical date after the battery has been changed.

The invention achieves this goal with a method for setting the calendar work of a clock exhibiting the features of patent claim 1, and with a device exhibiting the features of patent claim 10.

Advantageous embodiments and elaborations of the invention are indicated in the secondary claims.

The method according to the invention comprises the following successive steps:
a) determining if it necessary to change the battery
b) bringing the calendar work into a predetermined reference position after establishing the need to change the battery
c) determining that the battery has been changed
d) determining the current date to be set on the calendar work after the new battery has been inserted
e) setting the determined date on the calendar work, starting from the reference position into which the calendar work was brought after establishing that the battery must be changed.

In order to execute this method, a device with the following individual components is required:
a) means for determining if the battery needs to be changed
b) means for bringing the calendar work into a predetermined reference position
c) means for determining that the battery has been changed
d) means for determining the current date to be set on the calendar work
e) means for setting the determined date on the calendar work, starting from the reference position.

It is known that the battery voltage decreases with an increasing discharge. The need to change the battery is indicated, e.g., when the battery voltage has fallen below a predetermined voltage value. According to the invention, therefore, the means for determining the need to change the battery include a measuring device which measures the battery voltage when the battery is subjected to a load. If it is determined that the battery voltage lies below a predetermined value, this status is communicated to a central control unit, which causes the calendar work (e.g., a mechanically turning wheel with the days of the months indicated by numbers “1” to “31” or the days of the week indicated by “Mon, Tu, Wed, Th, Fr, Sat, Sun”) to be switched to a predetermined reference position.

For example, in the case of a clock with an analogue display exhibiting a motion work controlled by one or more step motors, information on the charge status of the battery is given by the tracking accuracy of the hand, as based on the control pulses required of the step motor(s) to move the hand. With an increasing discharge, a larger number of control pulses for correcting the hand position, or of control pulses with a variant pulse form, is needed to bring the hands of the clock into the desired position. Therefore, an analysis of the motor(s) driven to control the hands, or to operate one or more of these hands, is useful in determining the need to change the battery.

Thus, in place of or in addition to the voltage monitoring device described above, the means provided by the invention for determining the need to change the battery may include an evaluating device which evaluates the control pulses required by a motor drive. If the control pulses suggest growing problems in the correct positioning of the hand, this circumstance is signaled to the central control unit, which causes the calendar work to be switched to the predetermined reference position.

The invention provides a memory (electronic or mechanical), in which the predetermined reference position is stored.

In order to ensure that the time and date are reset only after a battery change and not while the old battery is still in place, it must be determined (ideally, determined with certainty) that the old battery has been replaced by a new one. The determination that the inserted battery is a new one can again be reached by measuring the charge state of the inserted battery.

In accordance with the invention, the means for determining that the battery has been changed include a device which measures the battery voltage under a load. Further details on the evaluation and the control process are given below.

Alternatively or in addition, the means for determining that the battery has been changed may also include an device which evaluates control pulses necessary for a motor drive. Why this kind of evaluating device is suitable for determining the charge state of the battery was described in detail above; details were also given on evaluation and control.

There are various possibilities for setting the date on the calendar work after the battery has been changed. If the clock is a so-called radio-controlled wristwatch, the means for determining the current date to be set on the calendar work will advantageously include a receiving device, which receives a time signal transmitted by a time signal transmitter (e.g., the DCF77 time signal transmitted by the Federal Technical Institute for Physics in Braunschweig; DCF77 is composed of the letters D for Germany, C to indicate a long-wave transmitter, and F for proximity to Frankfurt: the Mainflingen transmitting point is located close to Frankfurt). The current date can be ascertained, and then set on the clock, on the basis on this received time signal, which also gives the current date.

For clocks without the receiver described above, and also for radio-controlled clocks, at least one actuating element may be provided for the case in which there is deficient or disrupted reception of the time signal; the actuating elements allows the user to input or set the current date on the calendar work.

In order to permit the user to set or input the given date, the invention provides a display device which is controlled by at least one actuating element and which reproduces (preferably in optical fashion) the date being set.

There can be an electronic display device in the form of a flat display, particularly a liquid crystal, LED, or electroluminescent display.

The mechanical display device can be realized by bringing one hand of the clock, particularly, e.g., the second hand, into a certain position by means of at least one actuating element (e.g., a clock crown, a push-button, or a switch), such that the position indicates a particular date by pointing to the clock dial. Thus the hand can be brought, e.g., to a position within the scale of minutes (“1” to “31”) to indicate a day of the month. It is also possible for certain positions to be assigned to the days of the week “Mon” to “Sun”.

The invention is next described in greater detail on the basis of the drawings. Shown are:

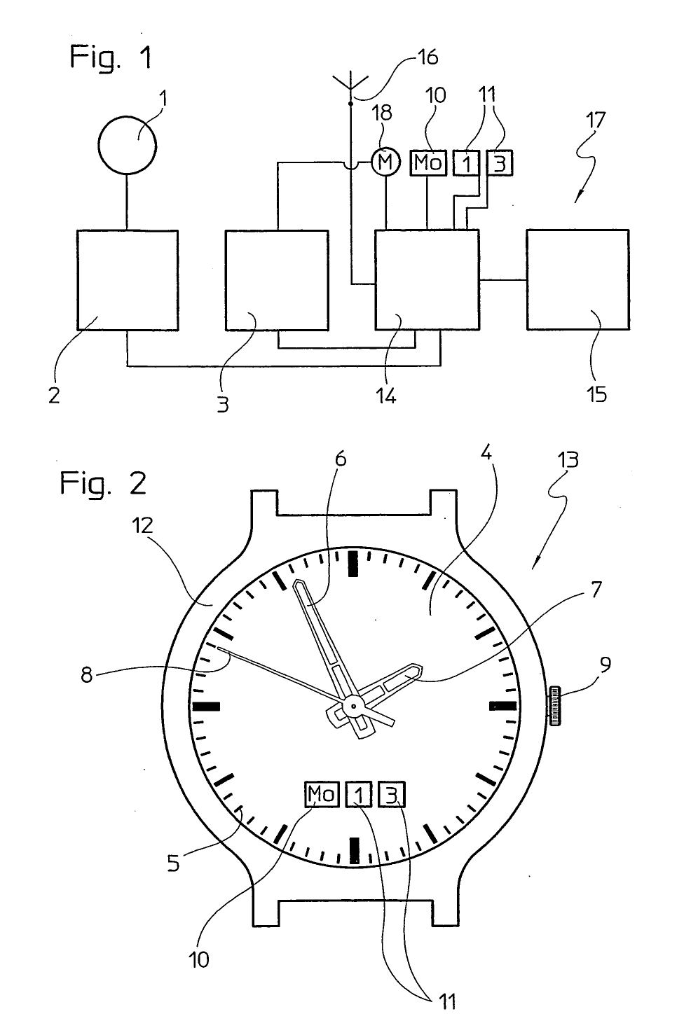

FIG. 1 an exemplary embodiment of an electronic control unit for setting the calendar work of a radio-controlled clock after the battery has been changed, in accordance with the invention

FIG. 2 a top view of a radio-controlled wristwatch, with calendar work

FIG. 2 gives a top view of a radio-controlled wristwatch, which in itself is of a conventional design. The radio-controlled wristwatch 13 includes a clock housing 12, which houses a clockwork (not shown) for driving an hour, minute, and second hand 6, 7, 8, as well as a calendar work exhibiting, in the present case, a day-of-the-week display 10 and a day-of-the-month display 11. In the present exemplary embodiment the day-of-the-week display 10 and the day-of-the-month display 11 are designed as small, mechanically rotating wheels, whose rotating axis lies in the drawing's plane of projection. Applied to the dial face 4 showing the scale of minutes 5 are holes through which the small wheels can be read. In principle, any other type of calendar work can be employed, particularly those involving liquid crystal displays or luminescent displays.

In an equally conventional design, a clock crown 9 is provided to adjust the position of the hands 6, 7, 8 and the calendar work 10, 11. In place of the clock crown 9, a push-button or other kind of adjusting device could be employed to set the hands 6, 7, 8 and the calendar work 10, 11 to the desired time and date.

Positioned inside the clock housing 12 is an electronic control device 17 of the type shown in FIG. 1. This electronic control unit 17 serves both to receive time signals for setting the day and time and to monitor the charge condition of a battery or accumulator.

The electronic control device 17 shown in FIG. 1 includes a battery 1 for providing electrical power to the electronic circuit of the control device 17. Several motors 18 are also provided for driving the hands 6, 7, 8 and the calendar work consisting of a day-of-the-week display 10 and a day-of-the-month display 11. To drive the motors 18 for the hands 6, 7, 8 and the calendar work 10, 11 there is a setting device 14, which is electrically connected to the components 18 described above. A receiver is also present for receiving time signals. In the present embodiment, this receiver is indicated by the antenna designated by reference numeral 16. There is a device 2 for measuring the battery voltage; this device 2 continuously measures the charge state of the battery 1, specifically when the battery is subject to a load. A device 3 for evaluating the motor pulse is provided in order to determine the movement of the motors 18 driving the hands 6, 7, 8 and the calendar work 10, 11, as based on the motor pulses required for movement of the motors 18. Finally, there is a storage device, which specifically serves to store a certain position, serving as reference position, occupied by the small wheels belonging to the calendar work 10, 11.

The electronic control device 17 of the invention operates according to the following schema:

The battery voltage meter 2 and the motor pulse evaluating device 3 monitor the charge state of the battery, directly in the case of the battery voltage meter and indirectly in the case of the motor pulse evaluating device. If, e.g., the battery voltage meter 2 establishes that the battery voltage of the battery 1 lies a certain amount below the nominal battery voltage, this battery voltage meter 2 signals the need to change the battery to the setting device 14. As an alternative, or in addition, the motor pulse evaluating device 3 evaluates the current pulse necessary for the movement of the motors 18. If the motor pulse evaluating device 3 determines, e.g., that the number of current pulses needed for a certain motor movement exceeds a predetermined nominal number of pulses, the motor pulse evaluating device 3 passes this information to the setting device 14.

When the electronic components have established that the battery's voltage is deficient, the setting device 14 will cause the calendar work 10, 11 to move to a predetermined position. This position is stored in the memory 15. The calendar work 10, 11 will now remain in this position until the battery has been changed.

A change in battery can be established, e.g., by the battery voltage meter 2, specifically when said device 2 determines that the battery voltage remains above a threshold value even when the battery is subject to a load. This threshold value may, e.g., be a given amount above the nominal voltage of the battery 1.

As an alternative, or in addition, the battery change can be ascertained when the motor pulse evaluating device 3 detects that the number of the current pulses needed to move the hands 6, 7, 8 and/or the calendar work 10, 11 remain below a predetermined threshold value.

In the present exemplary embodiment, both pieces of information are transmitted to the setting device 14.

If a time signal is then received by the antenna 16 and the corresponding receiver, the calendar work 10, 11 is moved from the reference position, which was already set after being stored in the memory 15, to the correct calendrical display.

Naturally it is possible to set the correct calendar date via actuating elements with displays using liquid crystal displays or second hands. After the input of information, the calendar work 10, 11 will move from the reference position to the correct date.

### Reference Numerals

1 battery

2 battery voltage meter

3 motor pulse evaluating device

4 clock face

5 scale of minutes

6 minute hand

7 hour hand

8 second hand

9 clock crown

10 day-of-week display

11 day-of-month display

12 clock housing

13 clock

14 setting device

15 memory

16 electronic control device

17 motor(s) for clock hands

1. A method for setting the calendar work of a clock, particularly a radio-controlled clock, after the battery has been changed,
wherein
the following method steps are executed:
a) determining if the battery needs to changed
b) bringing the calendar work into a predetermined reference position
c) determining that the battery has been changed
d) determining the current date to be set on the calendar work
e) setting the determined date on the calendar work, starting from the reference position.

2. A method according to claim 1,
wherein
the need for changing the battery is determined by directly measuring the battery voltage when the battery is subjected to a load.

3. A method according to claim 1,
wherein
the need for changing the battery is determined by evaluating control pulses required by a motor drive.

4. A method according to claim 1,
wherein
the predetermined reference position is stored in a memory.

5. A method according to claim 1,
wherein
completion of the battery change can be determined by directly measuring the battery voltage when the battery is subjected to a load.

6. A method according to claim 1,
wherein
completion of the battery change can be determined by evaluating the control pulses required by the motor drive.

7. A method according to claim 1,
wherein
the current date to be set on the calendar work is determined by receiving a time signal transmitted by a time-signal transmitter.

8. A method according to claim 1,
wherein
the current date to be set on the calendar work is determined by at least one actuating element as the result of a user input.

9. A method according to claim 8,
wherein
a display device is controlled by at least one actuating element, which displays the date to be set.

10. A device for setting the calendar work of a clock, particularly a radio-controlled clock, after the battery has been changed,
wherein
the following means are provided:
a) means for determining if the battery needs to changed
b) means for bringing the calendar work into a predetermined reference position
c) means for determining that the battery has been changed
d) means for determining the current date to be set on the calendar work
e) means for setting the determined date on the calendar work, starting from the reference position.

11. A device according to claim 10,
wherein
the means for determining the need to change the battery include a measuring device which measures the battery voltage when the battery is subjected to a load.

12. A device according to claim 10,
wherein
the means for determining the need to change the battery includes an evaluating device which evaluates control pulses required by a motor drive.

13. A device according to claim 10,
wherein
the is provided a memory in which the predetermined reference position is stored.

14. A device according to claim 10,
wherein
the means for determining that the battery has been changed include a measuring device which measures the battery voltage when the battery is subjected to a load.

15. A device according to claim 10,
wherein
the means for determining that the battery has been changed include an evaluating device which evaluates the control pulses required by the motor drive.

16. A device according to claim 10,
wherein
the means for determining the current date to be set on the calendar work include a receiver which receives a time signal transmitted by a time-signal transmitter.

17. A device according to claim 10,
wherein
there is provided at least one actuating element which permits the user to input the current date that is to be set on the calendar work.

18. A device according to claim 17,
wherein
there is provided a display device which can be controlled by at least one actuating element and which displays the date to be set.

19. A device according to claim 18,
wherein
the display device includes an electronic display device and/or a mechanical display device.

20. A device according to claim 19,
wherein
the electronic display device is a flat display, particularly a liquid crystal display, a LED display, or a electroluminescent display.

21. A device according to claim 18,
wherein
the mechanical display device includes a clock hand, particularly a second hand, which specifies a given date by pointing to the hours dial.
